(19) United States
(12) Patent Application Publication
(10) Pub. No.: US 2026/0230739 A1
(43) Pub. Date: Aug. 6, 2026

(54) CHARGER FOR GALVANIC CHARGING OF A HEARING DEVICE

(71) Applicant: Sivantos Pte. Ltd., Singapore (SG)

(72) Inventors: Sooriya Bandara Rathnayaka Mudiyanselage, Singapore (SG); Gee Heng Ler, Singapore (SG); Chee Kong Siew, Singapore (SG)

(21) Appl. No.: 19/045,746

(22) Filed: Feb. 5, 2025

(51) Int. Cl. H04R 1/1025; H02J 7/64; H02J 7/80; H02J 7/90; H04R 25/00

(52) U.S. Cl. CPC H04R 1/1025; H02J 7/64; H02J 7/80; H02J 7/90; H04R 25/602; H02J 2207/20

(57) ABSTRACT

A charger for galvanic charging of a hearing device has a supply interface, which is connected via a overvoltage protection to a power converter. The power converter converts a supply voltage of the supply interface into a charging voltage for at least one charging path ending in a charging interface. Each charging path has a current sensor for detecting a charging current, a modulation unit for an amplitude modulation of the charging voltage, and a current limiter for limiting the charging current. A controller for carrying out a charging process is coupled in terms of signaling to the power converter, the current sensor, and the modulation unit.

### FIELD AND BACKGROUND OF THE INVENTION

The invention relates to a charger for galvanic charging of a hearing device. The invention further relates to a charging system comprising such a charger and a hearing device.

Generally, a hearing device is an electronic device designed to support the hearing of a person wearing it (i.e., the user or wearer of the hearing device). In particular, the invention relates to a hearing aid, i.e., a hearing device that is specifically configured to at least partially compensate a hearing impairment of a hearing-impaired user. Other types of hearing devices are designed to support the hearing of normal hearing users, i.e., to improve speech perception in complex acoustic situations. Furthermore, the term hearing device, as used herein, may relate to a device for streaming an audio signal such as speech or music, e.g., a headset, headphone, ear buds, etc.

Hearing devices in general, and hearing aids in particular, are usually designed to be worn on the head, and in this case in particular on the head or on one of the user's ears, especially as behind-the-ear devices (BTE devices) or in-the-ear devices (ITE devices). With respect to its internal structure, a hearing device normally comprises an (acousto-electric) input transducer, a signal processor and an output transducer. During operation of the hearing device, the input transducer captures a sound signal from an environment of the hearing device and converts it into an input audio signal (i.e., an electric signal transporting a sound information). In the signal processor, the captured sound signal (i.e., input audio signal) is processed, in particular amplified dependent on sound frequency, to support the hearing of the user, in particular to compensate a hearing-impairment of the user, to suppress ambient noise, etc. The signal processor outputs a processed audio signal (also called processed sound signal) to the output transducer. Most often, the output transducer is an electro-acoustic transducer (also called “receiver”) that converts the processed sound signal into a processed air-borne sound, which is emitted into the ear canal of the user. Alternatively, the output transducer may be an electro-mechanical transducer that converts the processed sound signal into a structure-borne sound (vibrations) that is transmitted, e.g., to the cranial bone of the user. Furthermore, besides classical hearing instruments as described before, there are implanted hearing instruments such as cochlear implants, and hearing instruments the output transducers of which output the processed sound signal by directly stimulating the auditory nerve of the user.

Recently, hearing devices with rechargeable batteries have been increasingly manufactured. The battery can be recharged either wirelessly or by means of a non-contact charging connection. A charging connection is generally defined as an electrical device for supplying a charging current, i.e. an electric current for charging the rechargeable battery of the device. ‘Galvanic’ means that, in contrast to wireless charging, the charging connection enables an electrical current (i.e. an exchange of electrons) between a charger or charging cable and the electrical device. Such a galvanic charging is also referred to as contact charging, due to the physical contact or connection between the hearing device and a corresponding charging device (charger).

Compared to a wireless charging device, a galvanic charging connection usually has the advantage that it is comparatively compact and can therefore be installed in a space-saving way.

### SUMMARY OF THE INVENTION

The invention is based on the object of specifying a particularly suitable charger for galvanic charging of a hearing device. In particular, a particularly cost-effective charging circuit for the charger is to be specified. The invention is also based on the object of specifying a particularly suitable charging system.

According to the invention, the object is achieved in terms of the charger by the features of the independent charger claim, and in terms of the charging system in terms of the use by the features of the independent charging system claim. The dependent claims relate to advantageous embodiments and refinements. The advantages and embodiments mentioned regarding the charger can be transferred expediently also to the charging system, and vice versa

With the foregoing and other objects in view there is provided, in accordance with the invention, a charger for galvanic or contact charging of a hearing device. The hearing device comprises an integrated or internal rechargeable energy storage device (battery). Here and in the following, a ‘rechargeable energy storage device’ is understood to mean, in particular, a secondary battery of the hearing device, in which a consumed energy can be restored by means of an electrical charging process of the charger. The energy storage device can be designed, for example, as an electrochemical battery, in particular a rechargeable battery, for example as a lithium-ion rechargeable battery.

The charger includes a supply interface for connection to an external power supply. The supply interface is connected via an overvoltage protection to a power converter. During operation, i.e. during a charging process of a hearing device, said power converter converts a supply voltage of the supply interface into a charging voltage.

The charger has at least one charging path that connects the power converter to a charging interface. Each charging path comprises a current sensor for detecting a charging current during the charging process. The current sensor can be arranged between the power converter and the charging interface. Each charging path further comprises a modulation unit for an amplitude modulation of the charging voltage. Additionally, each charging path comprises a current limiter for limiting the charging current. The current limiter can be arranged between the modulation unit and the current sensor.

The charger further comprises a controller for carrying out a charging process. The controller is coupled in terms of signalling to the power converter, the current sensor and the modulation unit. This results in a particularly suitable charger for galvanic charging of a hearing device.

The supply interface can be a USB port, that supplies the charger with a constant (DC) supply voltage of e.g. 5 V (Volt). The hearing device has an energy store, for example, a lithium-ion battery, which, when fully charged, has an energy storage or battery voltage between 4.2 V and 4.35 V. The overvoltage protection is designed to detect an electrical voltage above a defined threshold value at the supply interface and to take measures to limit or divert the voltage in order to protect the controller and/or power converter.

The power converter can be a DC-DC-converter, which preferably maintains a common ground between input and output. In particular, the power converter can be one of the following: a buck converter, a SEPIC converter, a half-bridge buck converter, a cascaded buck-boost converter, a flyback converter, or a forward converter.

The charging interface of the charging path can be designed as a charging contact or charging connection (charging pin, charging plug, charging socket), so that a galvanic coupling to the hearing device is realised during the charging process. In other words, the hearing device has a complementary (counter) charging interface that galvanically connects to the charging interface of the charger in order to feed the charging energy (charging voltage/charging current) into the hearing device or into its internal energy storage device.

In a preferred embodiment, the charging interface is designed as a pogo contact. In this context, a pogo contact, or pogo pin contact, is a spring-loaded electrical contact consisting of a hollow, electrically conductive cylinder (barrel) and an axially movable, electrically conductive pin (plunger). The pin is pushed outwards by a spring inside the cylinder, with the spring force ensuring a reliable electrical connection. The pogo contact is typically designed to withstand repeated mechanical stresses and contact cycles.

The controller is generally set up - in terms of program and/or circuit technology - to carry out the charging process. The controller is thus specifically set up to set a charging voltage of the power converter at the start of a charging process and then, during the charging process, communicate with the hearing device or a charging controller thereof via the modulation unit, and adjust said charging voltage depending on the communicated information.

In a preferred embodiment, the controller can be formed at least in its core by a microcontroller with a processor and a data memory, in which the functionality for carrying out the charging process is implemented programmatically in the form of operating software (firmware), so that the method - possibly in interaction with a charger user - is carried out automatically when the operating software is executed in the microcontroller. Within the scope of the invention, the controller can alternatively be formed by a non-programmable electronic component, such as an application-specific integrated circuit (ASIC) or an FPGA (Field Programmable Gate Array), in which the functionality for carrying out the charging process is implemented by circuit-technical means.

In a conceivable embodiment the charger comprises a second power converter, which converts the supply voltage to an operating voltage for the controller. Said second power converter can be designed as a 3v3 converter, i.e., a converter which converts the supply voltage to 3.3 V.

The current sensor can be implemented using a series resistor in conjunction with an amplifier circuit. The amplifier's input is derived from the voltage drop across the series resistor, which creates a potential difference when the charging current flows through it. The amplifier then amplifies this voltage drop to a higher level and sends the output e.g. to an Analog-to-Digital Converter (ADC) input of the controller as the current sense level in voltage domain. The controller can use an algorithm to convert the ADC voltage input into a digital representation of the actual current flowing through the series resistor for further processing.

To facilitate the charging process, a robust and adaptive communication system is needed to enable reliable execution of the charging process. The modulation unit is intended, suitable and designed for a communication of the controller with the hearing device, especially with a charging controller thereof. The modulation unit is designed in particular for a bidirectional communication, i.e. the modulation unit can send modulated information to the hearing device and receive modulated information from said hearing device.

The modulation unit is especially designed for a load modulation, in particular for an amplitude modulation of the charging voltage. In amplitude modulation, the amplitude of the charging voltage is varied in proportion to that of the message signal to modulate the DC voltage to send data (load modulation signal).

During the charging process the modulation unit carries out a modulation step in which a load modulation signal is modulated onto the charging current or charging voltage created by the power converter. The modulated signal is transferred from the charger to the hearing device via the galvanic coupling at the charging interface. The hearing device can also create and transfer a load modulated signal to the charger, i.e. in opposite direction to the charging energy. The modulation unit is preferably design for a demodulation step in which the load modulation signal is demodulated in the charger.

During the charging process, a charging controller of the hearing device will send the charging information to charger by embedding the charging information into the load modulation signal. The charger will detect and demodulate the “load modulation” signal in order to receive the information of the hearing device charging process. Likewise, the charger will send command and information to the charging controller of the hearing device before and during the charging. The hearing device will send the charging information signal to the charger periodically, by request or event triggered. At the same time, the charger will send command and charger information to the hearing device by modulating the signal into the amplitude modulation signal on top of the charging energy. The bidirectional communication works at half-duplex communication, the charger will not send a modulated signal to the hearing device while receiving load modulation data from it and vice versa.

The current limiter is designed to limit the charging current flowing to a defined maximum value, in particular during the charging process, in order to prevent overcurrents in the hearing aid. An overcurrent situation during charging may be caused by a short circuit at the energy storage device of the hearing aid.

During the charging process a hearing aid is charged via the charging path and its charging interface. In a preferred embodiment the charger comprises two charging paths, each ending in a respective charging interface. Therefore, the charger can charge two hearing devices at the same time. This is especially advantageous for the charging of binaural hearing devices with two individual devices for the right and left ear. Existing charger designs for charging two hearing devices typically use a DC-DC converter output current limit which is typically high compared to charging current required for a two hearing device charging. Typically, one boost converter is used to charge two hearing aids. Therefore, both hearing aid stop charging when there is short circuit in one hearing device. In contrast to this, each charging path of the charger comprises a separate current limiter. Therefore, when there is a short circuit in one hearing device, the other hearing device can continue charging. This is useful when there is short circuit at night, such that a hearing device user can use the other hearing device the next day.

In a suitable embodiment, the overvoltage protection, the modulation unit and the current limiter can be designed as discrete electrical circuits. In other words, the overvoltage protection can be designed as a discrete overvoltage protection circuit, the modulation unit can be designed as a discrete modulation unit circuit, and the current limiter can be designed as a discrete current limiter circuit. This has the advantage of significantly reducing the manufacturing costs for the charger.

In this context, the term ‘discrete electrical circuit’ refers to an electrical circuit that consists of individual, physically separate components. Such components include, for example, resistors, capacitors, inductors, diodes and transistors that are not combined in an integrated circuit. The discrete electrical circuit is realised by connecting the components using conductors or wires.

In an expedient embodiment the overvoltage protection, the modulation unit and the current limiter each have at least three resistors and two transistors. In a conceivable embodiment, the overvoltage protection and the modulation unit each additionally have a Zener diode.

In a possible embodiment, the overvoltage protection or overvoltage protection circuit can comprise a voltage input connected to the supply interface and a voltage output coupled to the power converter.

In this embodiment, a first transistor can be connected on the input side to said voltage input and on the output side to said voltage output. The first transistor can be a (power) MOSFET (metal oxide semiconductor field-effect transistor), preferably a self-locking p-channel MOSFET, whose source is connected to the voltage input, and whose drain is connected to the voltage output.

Two nodes can be provided between said voltage input and said first transistor, wherein said first node can be connected via a series circuit comprising a first (ohmic) resistor and a Zener diode to ground. The cathode of the Zener diode is connected to the first resistor and its anode to the ground. Said second node can be connected to ground via a series circuit comprising a second transistor and a second (ohmic) resistor. The series circuits of the first and second node a preferably electrically parallel to each other. The second transistor can be a bipolar transistor, especially a PNP bipolar transistor, whose collector is connected to the second resistor, and whose emitter is connected to the second node.

A third node between said first resistor and said Zener diode can be connected to the control side of said second transistor, i.e. to its base, via a third (ohmic) resistor. The first transistor can be connected on the control side (i.e. via its gate) to a fourth node that is arranged between said second transistor and said second resistor.

The overvoltage protection protects the power converter from an overvoltage. The Zener diode monitors the input voltage, and when a certain voltage level is exceeded, the first transistor is activated to interrupt or divert the current flow. In other words, when the supply voltage at the voltage input exceeds a threshold value defined by the voltage drop over the first resistor and the breakdown voltage of the Zener diode, the Zener diode becomes conductive, and pulls the base of the second transistor to ground, thereby closing the first transistor.

The components of the overvoltage protection are preferably dimensioned such that the voltage level at the voltage output is limited to 5 V. Preferably after a trigger overvoltage condition at the voltage input of the overvoltage protection, the output voltage drops to 0 V within 300 μS (microseconds).

Current charger designs usually have integrated solutions for the overvoltage protection, which require external discrete components. In contrast to this, the overvoltage protection in this embodiment is realized completely with discrete components, which significantly reduces the costs for such an overvoltage protection.

In a conceivable embodiment, the current limiter can comprise a converter-side input connected to the power converter, and an interface-side output connected to the charging interface. Between the input and the output can be a series circuit of a first (ohmic) resistor and a first transistor. The first transistor can be a (power) MOSFET, preferably a self-locking p-channel MOSFET, whose source is connected to the first resistor, and whose drain is connected to the output of the current limiter.

A first node can be arranged between said input and said first resistor and a second node can be arranged between said first resistor and said first transistor. Said first transistor can be connected on the control side (gate) to ground via a second (ohmic) resistor. Said first node can be connected via a second transistor to a third node between the control side of said first transistor (gate) and said second resistor. The second transistor can be a bipolar transistor, especially a PNP bipolar transistor, whose emitter is connected to the first node, and whose collector is connected to the third node.

The second node can be connected to ground via a series circuit of a third (ohmic) resistor and a fourth (ohmic) resistor. The series circuit of the third and fourth resistor realizes a voltage divider, whose tap can be a fourth node connected to the control side (base) of said second transistor.

In this embodiment the current limiter uses the first transistor (MOSFET) as a current control element and the second transistor (bipolar transistor) as a monitoring and control element. As soon as the current exceeds a defined threshold (e.g. for a short circuit current), the bipolar transistor activates the MOSFET to limit the current flow. The components of the current limiter are preferably dimensioned such that after a trigger, the output charging current is capped at approximately 42 mA (milliamp) which is close to output charging current limit set point.

In an expedient embodiment, the modulation unit can comprise a converter-side input connected to the power converter, and an interface-side output connected to the charging interface. The current sensor can be connected between the interface-side of the modulation unit and the charging interface. Between the input and the output can be a first transistor. The first transistor can be a (power) MOSFET, preferably a self-locking p-channel MOSFET, whose source is connected to the input, and whose drain is connected to the output of the modulation unit.

A Zener diode can be connected in parallel with said first transistor, such that the anode of the Zener diode is connected to the source of the first transistor and that the cathode of the Zener diode is connected to the drain of the first transistor.

A first node can be arranged between said input and said first transistor, wherein said first node can be connected to ground via a series circuit comprising a first (ohmic) resistor and a second transistor. The second transistor can be a bipolar transistor, especially a PNP bipolar transistor, whose emitter is connected to ground, and whose collector is connected to the first resistor. A second node can be arranged between said first resistor and said second transistor and can be connected to a control side (gate) of said first transistor via a second (ohmic) resistor.

The control side (base) of said second transistor can be connected to the controller via a third (ohmic) resistor. The controller can be connected to the third resistor via a digital output of the controller. A third node located between said third resistor and said second transistor can be connected to ground via a fourth resistor.

The output of the controller is the modulation signal controlling the second transistor, which in turn controls the Gate-Voltage of the first transistor, causing a variation of the drain current and modifying the amplitude of the carrier signal (charging voltage).

Existing designs for load or amplitude modulation comprise an adjustable voltage regulator that is used to control the charging voltage to send data from the charger to the hearing device. A typical adjustable voltage regulator circuit comprises a reference voltage to control the charging voltage. The reference voltage can be controlled by a microcontroller with digital to analog converter (DAC) which is connected to a control voltage. The modulation unit or discrete modulation unit circuit of this embodiment is a simple solution which can be controlled using any controller digital output without a DAC output. The modulation unit can therefore be controlled using a simple digital signal of the controller. The modulation unit of this embodiment has a significantly reduced cost as compared to an adjustable voltage control circuit, which in turn has the advantage of significantly reducing the manufacturing costs for the charger.

The charging system comprises a chargeable hearing device and a charger as described above. This produces a particularly suitable charging system.

In a conceivable embodiment, the hearing device comprises a (device) charging interface for coupling to the charger, a rechargeable energy storage device (battery) and a charging controller, coupled between the charging interface and the energy storage device. Preferably, the hearing device is a hearing aid.

Other features which are considered as characteristic for the invention are set forth in the appended claims.

Although the invention is illustrated and described herein as a charger for a binaural hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic and simplified illustration of a charging system with a charger according to the invention;

FIG. 2 is a circuit diagram for an overvoltage protection of the charger;

FIG. 3 is a circuit diagram for a current limiter of the charger; and

FIG. 4 is a circuit diagram for a modulation unit of the charger.

Parts and variables which correspond to one another are always provided with the same reference signs in all the figures.

### DETAILED DESCRIPTION OF THE INVENTION

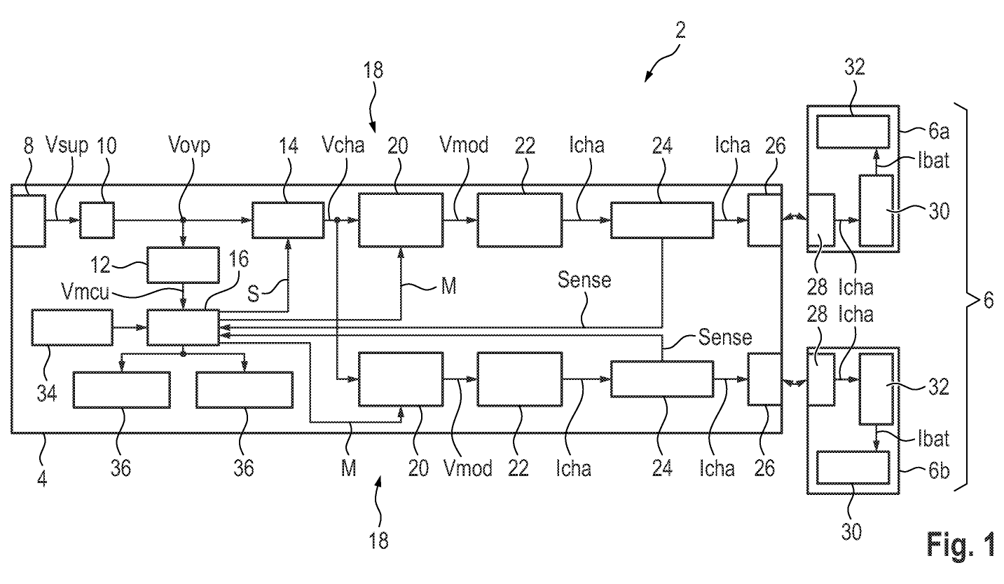

Referring now to the figures of the drawings in detail and first, particularly to FIG. 1 thereof, there is shown a simplified and schematic illustration of a charging system 2 with a charger 4 and a binaural hearing device 6 comprising two hearing aids 6a, 6b.

The charger 4 comprises a supply interface 8 for connecting the charger 4 to an external power supply. The supply interface 8 can be designed as an USB-port to connect the charger 4 with a USB charging cable connected to a power outlet. During operation the supply interface 8 provides a constant (DC) supply voltage Vsup (e.g. 5 V) to the charger 4. t

The supply interface 8 is connected to an overvoltage protection 10 that protects the charger 4 and its components from an overvoltage. If the supply voltage Vsup exceeds a defined threshold limit of the overvoltage protection 10, the overvoltage protection 10 reduces the voltage Vovp at its output to 0 V. The overvoltage protection 10 can be dimensioned such that the output voltage Vovp drops to 0 V within 300 μS after the threshold is exceeded. The overvoltage protection 10 can be preferably dimensioned such that the voltage level at the voltage output is limited to a maximum of 5 V.

The charger 4 further comprises two power converters 12 and 14, which are connected to the overvoltage protection 10.

The power converter 12 is preferably a step-down DC-DC converter, that converts the voltage Vovp of the overvoltage protection 10 to a lower voltage Vmcu, e.g. to 3.3 V, for an on-board controller 16 of the charger 4. Said controller 16 can include integrated circuits or can be preferably designed as a microcontroller. The controller 16 controls the charging process of the charger 4 during operation.

The power converter 14 is preferably a step-up DC-DC converter, that converts the voltage Vovp of the overvoltage protection 10 to a higher voltage level that is used as a charging voltage Vcha for charging the hearing device 6. In particular, the power converter 14 can be one of the following: a buck converter, a SEPIC converter, a half-bridge buck converter, a cascaded buck-boost converter, a flyback converter, or a forward converter. The power converter 14 is signally coupled with the controller 16, which can adjust the level of the charging voltage Vcha via a control signal S.

The power converter 14 is connected to one charging path 18 for each of the hearing aids 6a, 6b. Each charging path 18 comprises a modulation unit 20, a current limiter 22, a current sensor 24 and a charging interface 26.

The modulation unit 20 is signally coupled with the controller 16. The modulation unit 20 is designed for a bidirectional communication with the respective hearing aid 6a, 6b. In other words, the modulation unit 20 is intended and set up to transmit and receive modulated signals.

The modulation unit 20 is designed for a load modulation, especially an amplitude modulation, of the charging voltage Vcha. In other words, the modulation unit 20 uses the charging voltage Vcha as a carrier signal that is varied in proportion to a digital message signal M of the controller 16. The modulation unit 20 outputs a modulated voltage signal Vmod.

The current limiter 22 is designed to limit a charging current Icha for the respective hearing aid 6a, 6b to a permissible current value. The charging current Icha is linked to the charging voltage Vcha or the voltage signal Vmod via the ohmic law.

The current sensor 24 is designed for detecting the value of the charging current Icha during the charging process. The current sensor 24 transmits sensor signals Sense coupled to the controller 16. The current sensor 24 can be part of a combined current-voltage sensor (VI sensor) that measures both the charging current Icha as well as the charging voltage Vcha (or voltage signal Vmod) at the charging interface 26 and send corresponding sensor signals Sense to the controller 16. During charging operation, the measured voltage is used in particular to regulate the charging voltage Vcha via the control signal S in order to maintain it at a desired voltage level, while the current sensor 24 continuously monitors the charging current Icha.

The charging interface 26 is designed in particular as a charging contact or charging connection (charging contact connection), which is galvanically coupled to a (device) charging interface 28 of the respective hearing aid 6a, 6b during a charging process. The charging interfaces 26, 28 are designed, for example, as a plug/socket pair for a plug connection.

The hearing aid 6a, 6b comprises the charging interface 28, a charging controller 30 and an energy storage device 32 that can be recharged by the charger 4. The charging controller 30 is connected to the charging interface 28 on the one hand and to the energy storage device 32 on the other hand. The energy storage device 32 is designed in particular as an accumulator, preferably as a lithium-ion battery. A battery voltage of the energy storage device 32 is dimensioned, for example, between 3.0 V and 4.2 V during operation of the hearing aid 6a, 6b.

Due to a certain current consumption in the charging controller 30, the charging current Icha flowing via the charging interfaces 26, 28 is slightly higher than the charging current associated with the respective state of charge. The charging controller 30 therefore outputs a battery current Ibat flowing to the energy storage device 32.

The charger 4 further comprises a thermistor 34, which is signally coupled to the controller 16. The controller 16 monitors the temperature of the charger 4 via the thermistor 34 and activates protective mechanisms (e.g. switch off or reduce power) if the temperature rises too high.

The controller 16 is further coupled to two indicator elements 36. The indicator elements 36 can be LEDs which indicate a connection between the charger 4 and each of the hearing aids 6a, 6b and/or if a charging process is in progress for the hearing aids 6a, 6b.

The overvoltage protection 8, the modulation unit 20 and the current limiter 22 are preferably designed as discrete electrical circuits, which are explained in more detail below.

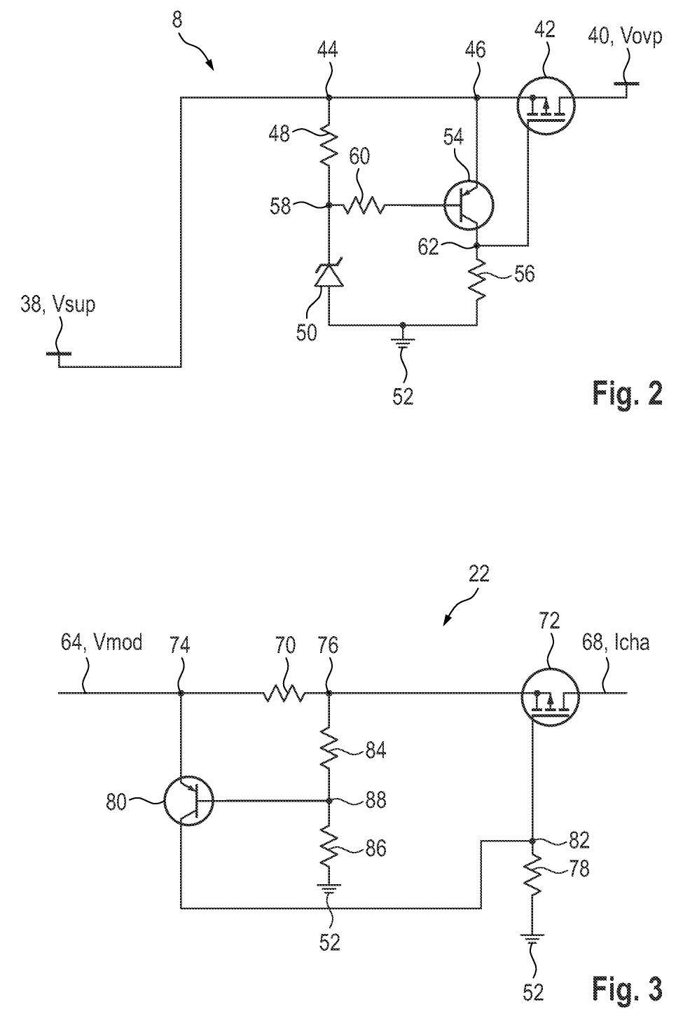

FIG. 2 shows a preferred embodiment for the overvoltage protection 8. The overvoltage protection 8 can comprise a voltage input 38 connected to the supply interface 8 and a voltage output 40 coupled to the power converter 26.

A first transistor 42 can be connected on the input side to the voltage input 38 and on the output side to the voltage output 40. In the embodiment shown in FIG. 2 the transistor 42 is a (power) MOSFET, preferably a self-locking p-channel MOSFET, whose source is connected to the voltage input 38, and whose drain is connected to the voltage output 40.

Two nodes 44, 46 are located between the voltage input 38 and the transistor 42. A first node 44, which is located closer to the voltage input 38, is connected via a series circuit comprising a first (ohmic) resistor 48 and a Zener diode 50 to ground 52. The cathode of the Zener diode 50 is connected to the resistor 48 and its anode to the ground 52.

The second node 46, which is located closer to the transistor 42, is connected to ground 52 via a series circuit comprising a second transistor 54 and a second (ohmic) resistor 56. The series circuits of the nodes 44, 46 are electrically parallel to each other. The transistor 54 is designed as a bipolar transistor, especially a PNP bipolar transistor, whose emitter is connected to the node 46, and whose collector is connected to the resistor 56.

A (third) node 58 is arranged between the resistor 48 and the Zener diode 50. The node 58 is connected to the control side (base) of the transistor 54 via a third (ohmic) resistor 60. The control side (gate) of the transistor 42 is connected to a (fourth) node 62. The node 62 is arranged between the transistor collector of the transistor 54 and the resistor 56.

FIG. 3 shows a preferred embodiment for the current limiter 22. The charger 4 comprises two independent current limiters 22, one in each of the charging paths 18, to separately control the charging paths 18 for each hearing aid 6a, 6b.

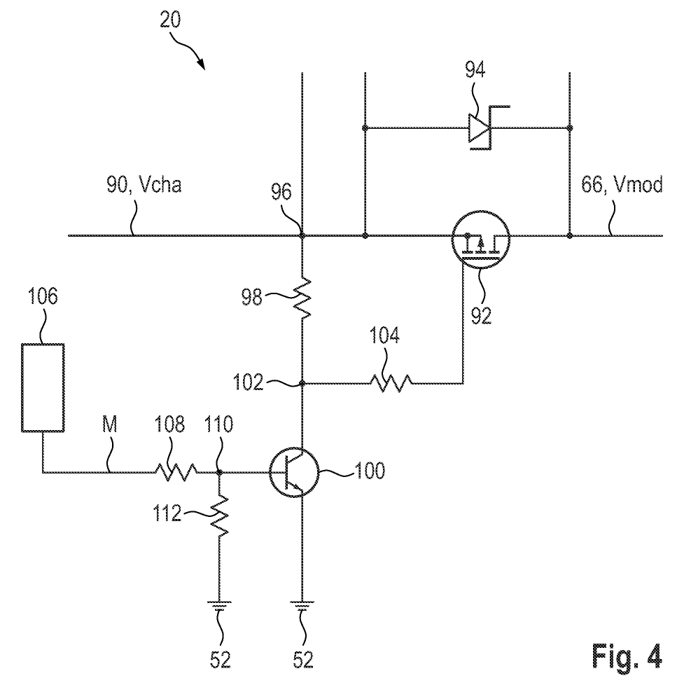

In the shown embodiment, the current limiter 22 comprises an input 64, which is connected to an output 66 (FIG. 4) of the modulation unit 20. The current limiter 22 further comprises an output 68 output connected to the charging interface 26 via the current sensor 24.

Between the input 64 and the output 68 is a series circuit of a first (ohmic) resistor 70 and a first transistor 72. The transistor 72 is designed as a (power) MOSFET, preferably a self-locking p-channel MOSFET, whose source is connected to the resistor 70, and whose drain is connected to the output 68.

A first node 74 is arranged between the input 64 and the resistor 70 and a second node 76 is arranged between the resistor 70 and source of the transistor 72. The transistor 72 is connected on the control side (gate) to ground 52 via a second (ohmic) resistor 78.

The node 74 is connected via a second transistor 80 to a third node 82 between the gate of the transistor 72 and the resistor 78. The transistor 80 is a bipolar transistor, especially a PNP bipolar transistor, whose emitter is connected to the node 74, and whose collector is connected to the node 82.

The node 76 is connected to ground 52 via a series circuit of a third (ohmic) resistor 84 and a fourth (ohmic) resistor 86. The series circuit of the resistors 84 and 86 realizes a voltage divider, whose tap is used as a fourth node 88 connected to the control side (base) of the transistor 80.

FIG. 4 shows a preferred embodiment for the modulation unit 20 as an amplitude modulation circuit of the charging path 18. The charger 4 comprises two independent modulation units 20, one in each of the charging paths 18, to realize a bidirectional communication between the controller 16 and each of the hearing aids 6a, 6b.

In the shown embodiment, the modulation unit 20 comprises an input 90, which is connected to an output of the power converter 14. The modulation unit 20 further comprises the output 66 connected to the input 64 of the current limiter 22.

A first transistor 92 is connected between the input 90 and the output 66. The transistor 92 is designed as a (power) MOSFET, preferably a self-locking p-channel MOSFET, whose source is connected to the input 90, and whose drain is connected to the output 66.

A Zener diode 94 is connected in parallel with the transistor 92, such that the anode of the Zener diode 94 is connected to the source of the transistor 92 and that the cathode of the Zener diode 94 is connected to the drain of the transistor 92.

A first node 96 is arranged between the input 90 and the source of the transistor 92, wherein said node 96 is connected to ground 52 via a series circuit comprising a first (ohmic) resistor 98 and a second transistor 100. The transistor 100 is designed as a bipolar transistor, especially a PNP bipolar transistor, whose emitter is connected to ground 52, and whose collector is connected to the resistor 98.

A second node 102 is arranged between the resistor 98 and the collector of the resistor 98. The node 102 is connected to the gate of the transistor 92 via a second (ohmic) resistor 104.

The base of the transistor 100 is connected to a digital output 106 of the controller 16 via a third (ohmic) resistor 108. A third node 110 is located between the resistor 108 resistor and the base of the transistor 100. The node 110 is connected to ground 52 via a fourth resistor 112.

The modulation unit 20 is a simple and cost-effective solution for a bidirectional communication between the controller 16 and the charging controller 32 of the respective hearing aid 6a, 6b. The amplitude modulation of the modulation unit 20 can be controlled using a simple digital signal of the controller 16 as message signal M. The modulation unit 20 of this embodiment has a significantly reduced cost as compared to an adjustable voltage control circuit, which in turn has the advantage of significantly reducing the manufacturing costs for the charger 4.

The claimed invention is not limited to the embodiments described above. Rather, other variants of the invention may also be derived therefrom by the skilled person within the scope of the disclosed claims without departing from the object of the claimed invention. In particular, all the individual features described in connection with the various embodiments can also be combined in other ways within the scope of the disclosed claims without departing from the object of the claimed invention. It should be noted that all features disclosed in this application are originally disclosed individually and in all combinations. In particular, the features of the disclosed claims can also be combined with one another, provided that this does not result in any explicit contradiction between the features themselves or with the description described above.

The following is a summary list of reference numerals and the corresponding structure used in the above description of the invention:

2 charging system

4 charger

6 hearing device

6a, 6b hearing aid

8 supply interface

10 overvoltage protection

12 power converter

14 power converter

16 controller

18 charging path

20 modulation unit

22 current limiter

24 current sensor

26 charging interface

28 charging interface

30 charging controller

32 energy storage device

34 thermistor

36 indicator element

38 voltage input

40 voltage output

42 transistor

44 node

46 node

48 resistor

50 zener diode

52 ground

54 transistor

56 resistor

58 node

60 resistor

62 node

64 input

66 output

68 output

70 resistor

72 transistor

74 node

76 node

78 resistor

80 transistor

82 node

84 resistor

86 resistor

88 node

90 input

92 transistor

94 zener diode

96 node

98 resistor

100 transistor

102 node

104 resistor

106 digital output

108 resistor

110 node

112 resistor

Vsup supply voltage

Vovp voltage

Vmcu voltage

Vcha charging voltage

Vmod modulated voltage

Icha charging current

M message signal

S control signal

Sense sensor signal

Ibat battery current

1. A charger for galvanic charging of a hearing device, comprising:
a supply interface, which is connected via an overvoltage protection to a power converter, said power converter being configured to convert a supply voltage of said supply interface into a charging voltage for at least one charging path ending in a charging interface;
each said charging path having a current sensor for detecting a charging current, a modulation unit for an amplitude modulation of the charging voltage, and a current limiter for limiting the charging current; and
a controller for carrying out a charging process is coupled in terms of signaling to the power converter, the current sensor and the modulation unit.

2. The charger according to claim 1, wherein said overvoltage protection, said modulation unit, and said current limiter are discrete electrical circuits.

3. The charger according to claim 1, wherein each said overvoltage protection, said modulation unit, and said current limiter has at least three resistors and two transistors.

4. The charger according to claim 2, wherein each said overvoltage protection and said modulation unit additionally has a Zener diode.

5. The charger according to claim 1, wherein said overvoltage protection has a voltage input connected to the supply interface and a voltage output coupled to said power converter,
a first transistor being connected on the input side to said voltage input and on the output side to said voltage output,
two nodes being provided between said voltage input and said first transistor,
said first node being connected to ground via a series circuit comprising a first resistor and a Zener diode,
said second node being connected to ground via a series circuit comprising a second transistor and a second resistor,
a third node between said first resistor and said Zener diode is connected to the control side of said second transistor via a third resistor, and
said first transistor being connected on the control side to a fourth node arranged between said second transistor and said second resistor.

6. The charger according to claim 1, wherein said current limiter has a converter-side input and an interface-side output, between which a series circuit of a first resistor and a first transistor is connected,
a first node being arranged between said input and said first resistor and a second node being arranged between said first resistor and said first transistor,
said first transistor being connected on the control side to ground via a second resistor,
said second node being connected to ground via a series circuit of a third resistor and a fourth resistor,
said first node being connected via a second transistor to a third node between the control side of said first transistor and said second resistor, and
said second transistor being connected on the control side to a fourth node between said third and fourth resistor.

7. The charger according to claim 1, wherein said modulation unit has a converter-side input and an interface-side output, between which a first transistor is connected,
a Zener diode being connected in parallel with said first transistor,
a first node being arranged between said input and said first transistor,
said first node is connected to ground via a series circuit comprising a first resistor and a second transistor,
a second node arranged between said first resistor and said second transistor is connected to a control side of said first transistor via a second resistor,
the control side of said second transistor is connected to the controller via a third resistor, and
a third node between said third resistor and said second transistor is connected to ground via a fourth resistor.

8. A charging system, comprising:
a charging device according to claim 1 and a hearing device to be charged by said charging device.

9. The charging system according to claim 8, wherein said hearing device, has a charging interface for coupling to the charging interface of the charger, a rechargeable energy storage device, and a charging controller connected between said charging interface and said energy storage device.
